(19) United States
(12) Patent Application Publication
(10) Pub. No.: US 2007/0223561 A1
(43) Pub. Date: Sep. 27, 2007

(54) WORKING ELECTRODE STRUCTURE OF BIOSENSOR FOR REDUCING MEASUREMENT ERROR

(76) Inventors: Yon Chan Ahn, Gyeonggi-do (KR); Jun Oh Ryu, Anyang-si (KR); Seung Joo Kang, Seoul (KR)

Correspondence Address: LAW OFFICES;WHITHAM, CURTIS & CHRISTOFFERSON, P.C., SUITE 340, 11491 SUNSET HILLS ROAD, RESTON, VA, 20190, US

(21) Appl. No.: 11/383,281

(22) Filed: May 15, 2006

(30) Foreign Application Priority Data
Mar. 22, 2006 (KR) 10-2006-0026005

(51) Int. Cl. G01K 13/00; G01K 7/00

(52) U.S. Cl. 374/142; 374/28; 374/185

(57) ABSTRACT

Disclosed herein is a working electrode structure of a biosensor, in which the shape of one end of the working electrode including a reaction portion is modified to have different electrode widths for each section along a lengthwise direction within the reaction portion, so that although there is caused a length error in the reaction portion of the working electrode in the process of fixing a reagent during the fabrication of the electrode, an error for an area of the reaction portion can be restricted at the maximum, which results in a reduction in measurement error and an improvement in measurement reliability.

### CROSS-REFERENCE TO RELATED APPLICATIONS

This application claims priority of Korean Application No. 10-2006-0026005, filed on Mar. 22, 2006, the disclosure of which is incorporated fully herein by reference.

### BACKGROUND OF THE INVENTION

1. Field of the Invention

The present invention relates to a working electrode structure of a biosensor for reducing a measurement error, and more particularly to such a working electrode structure of a biosensor, in which the shape of one end of the working electrode including a reaction portion is modified to have different electrode widths for each section along a lengthwise direction within the reaction portion, so that although there is caused a length error in the reaction portion of the working electrode in the process of fixing a reagent during the fabrication of the electrode, an error for an area of the reaction portion can be restricted at the maximum, which results in a reduction in measurement error and an improvement in measurement reliability.

2. Background of the Related Art

Recently, electrochemical biosensors are frequently used in medical fields to analyze biomaterials including blood.

A biosensor refers to a system which converts a biological binding event or the reaction of a biological molecule to a target chemical into a recognizable, measurable useful signal such as color, fluorescence, electrical signals, and the like through the use or imitation of any kind of biological components when it is desired to obtain information from a measured-to-be-target.

The use of such a biosensor was mainly concentrated on a blood sensor field which leads to an increase in clinical demand only ago several years. However, recently, efforts is being made to develop diverse sensors into which the characteristics of multi-fields are incorporated in line with the rapid development of molecular biology, nanotechnology (NT), and information and communication technology (ICT). Also, such a biosensor attracts much interest from a view point of mass-retrieval, multiple measurements or multiple diagnoses in addition to a simple biochemical aspect.

As well known, a medical field creates the greatest demand on the biosensor, in which as free movement is possible instantaneous detection can be performed so that the use of medicines is facilitated which represent a high degree of danger in the medical field, and a rapid medical diagnosis and treatment for critically ill patients is enabled so that it can be expected that the demand on the biosensor would be continuously expanded in medical fields.

An example of a system applied to such a medical field includes a biosensor which can quantitatively analyze specific biomaterials such as blood sugar, cholesterol and so forth. Diverse researches on performance improvement and new technology development are in progress by biosensor manufacturers all over the world.

A biosensor which has been most widely used till recently is a glucose sensor for measuring blood sugar.

An example of the glucose sensor will now be described hereinafter.

The glucose sensor has been developed incessantly till now based on a first sensor fabricated by a method in which a glucose oxidase (GOD) which oxidizes glucose is inclusively immobilized on a polyacrylamide gel membrane to form a resultant membrane and this resultant membrane is affixed to a diaphragm sensor electrode.

The GOD, which is an enzyme used in the glucose sensor, is available easily and inexpensively, and is more stable in terms of Ph, ion strength and temperature as compared to other enzymes. Also, the GOD is widely used because an optimum condition where the GOD oxidizes glucose is identical to the concentration of glucose in human blood.

Such an analysis method of the glucose sensor is largely classified into a photometric method and an electrochemical method, both of which employ an oxidase which can basically react with glucose to oxidize the glucose.

The photometric method employs chromogen bringing about a change in color upon the oxidization of glucose so that reflectance and transmittance of light is measured by using a photometer so as to quantize a degree of color change.

On the contrary, in the electrochemical method, when glucose is oxidized, oxygen or oxidized mediator is converted into hydrogen peroxide or reduced mediator and then is re-oxidized so that electrons generated when the hydrogen peroxide or reduced mediator returns to an original oxidized form is measured in the form of current flowing through electrodes so as to quantize glucose.

The photometric method generally has a relatively extended measurement time and requires a relatively large amount of blood as compared to the electrochemical method, and has a difficulty in analysis of significant biomaterials due to the measurement errors caused by the turbidity of biomaterials.

Therefore, the electrochemical method is extensively applied in biosensors recently. According to the electrochemical method, the quantitative measurement of a material of interest among biomaterials can be achieved by exposing only a portion of the electrode onto which an analyte is fixed, applying and fixing the analyte reacting with measurement components in the biomaterials on the exposed electrode portion in a state where the remaining portions of the electrode is shielded, introducing biomaterials such as blood, and applying an certain electric potential across the electrode through the use of screen printing, film adhesion or the like after formation of an electrode.

U.S. Pat. No. 5,437,999 entitled “Electrochemical Sensor” discloses an electrochemical biosensor test strip with a precisely defined electrode field applying technologies generally used in PCB industries adequately to an electrochemical biosensor test strip.

This electrochemical biosensor test strip can perform an electrochemical measurement very precisely with a small amount of samples.

Also, as a patent related to the electrochemical biosensor, the present applicant has filed a patent application entitled “Electrochemical biosensor test strip having recognition electrode and readout meter using the same” (Registration No. 385832).

The above U.S. Patent provides a merit in that since an analyte of the test strip can be automatically recognized without any button manipulation of a biosensor readout meter, various blood components such as blood sugar, cholesterol, GOT, GPT and so forth can be easily analyzed quantitatively by using one readout meter. In addition, since the readout meter does not require a separate socket, the manufacturing cost is very low and it is possible to simply and easily fabricate a check strip using a recognition electrode and a resistor, which makes it possible to calculate a precise concentration of the analyte.

The Korean Patent Registration No. 515,438 filed by the applicant of the present invention discloses a method of fabricating an electrochemical sensor using a film. The above Korean patent provides several advantages in that a sputtering process is simple, an electrode can be formed in size uniformly, a measurement precision can be improved and the film can be utilized appropriately.

Besides these, the Korean Patent Laid-Open Publication No. 2005-96490 discloses an electrochemical biosensor readout meter in which a voltage converting means is set to convert peak current occurring at the application time of voltage into a corresponding voltage with no distortion using an electrochemical biosensor test strip formed with an electrode, and an amplifier is set to make a digital voltage signal at the measurement time lower than a reference voltage of an A/D converter. Accordingly, the above Korean patent provides a high reproducibility and an improvement in reliability.

In the meantime, FIG. 4 is a plan view illustrating an electrode structure of a conventional electrochemical biosensor test strip according to the prior art.

As shown in FIG. 4, a conventional electrochemical biosensor test strip 1 includes an insulating substrate 2, a working electrode 3 and a reference electrode 34 which is formed in a rectangular shape and are formed parallel in a lengthwise direction on the insulating substrate 2, and a recognition electrode 5 formed on one end portion of the insulating substrate 2.

In FIG. 4, a rectangular electrode which is smaller in transverse width is the working electrode 3 in which there occurs the oxidization-reduction reaction between an analyte in a sample and a reagent, and a rectangular electrode which is larger in transverse width is the reference electrode 4.

In addition, the recognition electrode 5 is formed at a predetermined position on the electrochemical biosensor test strip 1 that is determined depending on which material a reagent fixed over the working electrode 3 and the reference electrode 4 will detect. In this case, when this test strip 1 is inserted into the biosensor readout meter, the biosensor readout meter identifies the position of the recognition electrode 4 on the test strip 1 and hence can identify which material the test strip 1 will analyze.

In order to fabricate the above electrochemical biosensor test strip 1, after an electrode material is sputtered onto a given area on the insulating substrate 2 to form an electrode, only a portion of the electrode onto which an analyte is fixed is exposed to the outside, and the analyte reacting with measurement components in the sample is applied and fixed on the exposed electrode portion in a state where the remaining portions of the electrode is shielded.

For example, in FIG. 4, after insulating the remaining area of the electrodes except an exposed rectangular area on which a reagent is fixed, by using screen printing or film adhesion, the reagent is fixed on the exposed rectangular area to thus form the reagent fixing portion 6.

Meanwhile, in a biosensor which achieves the transfer of electrons through the working electrode 3, a current signal is generated for a given period of time while the electrons are generated through reaction in the working electrode 3 after the charging of the sample. At this time, the current signal is read out by the readout meter which in turn quantitatively analyzes corresponding components in the sample.

At this time, when the same reaction occurs in the working electrode 3, the same current signal must be generated.

That is, although the measurement is performed using several test strips 1, since the reactions of the components in the sample and the reagent in the working electrode 3 are the same with respect to the samples whose components are the same (i.e., the components as measured-to-be-targets are the same), identical current signals must be output.

However, this is premised on the fact that the area of a portion (a reaction portion 3a) of the working electrode 3, on which the reagent is fixed, must be identical for each test strip 1 with respect to all the fabricated test strips 1.

If the test strip is fabricated such that there is a difference in the area of a portion (the reaction portion 3a) of the working electrode within the reagent fixing portion 6 for each test strip 1 in the fabrication process of the test strip, the area of the reaction portion between the reagent and the component in the sample in the working electrode 3 is changed so that despite the same samples there occurs a difference between current signals to be output.

Accordingly, in order to reduce a measurement error and increase reliability, the areas of the reaction portions 3a of the working electrodes 3 in all the test strips 1, i.e., the areas of portions on which the reagent is fixed in the working electrodes 3 must of course be identical to one another without any fine error.

However, during the actual fabrication process of the test strip, it is difficult to fabricate test strips to make the areas of the reaction portions 3a (portions on which a reagent is fixed) of the working electrodes 3 completely identical to one another without any fine error for all the test strips 1. Accordingly, the present invention is focused on maximally reducing a process tolerance to decrease an area error between the reaction portions 3a of the working electrodes 3 and thus maximally reduce the measurement error.

To this end, the process tolerances of the areas of the reagent fixing portions exposed to the outside at the time of performing the insulating process by means of screen printing, film adhesion or the like for all the test strips during the fabrication process of the test strip, i.e., the process tolerances of the areas of the portions on which the reagent is fixed in the working electrodes must be reduced to make the areas of the reagent fixing portions identical to one another. However, the research or effort for improvement for such a problem is still insufficient.

### SUMMARY OF THE INVENTION

Accordingly, the present invention has been made in view of the aforementioned problems occurring in the prior art, and it is an object of the present invention to provide a working electrode structure of a biosensor, in which the shape of one end of the working electrode including a reaction portion is modified to have different electrode widths for each section along a lengthwise direction within the reaction portion, so that although there is caused a length error in the reaction portion of the working electrode in the process of fixing a reagent during the fabrication of the electrode, an error for an area of the reaction portion can be restricted at the maximum, which results in a reduction in measurement error and an improvement in measurement reliability.

To accomplish the above object, according to one aspect of the present invention, there is provided a structure of a working electrode of an electrochemical biosensor, the working electrode including a reaction portion of a certain section on which an analyte is fixed, wherein one end portion of the working electrode including the reaction portion and a boundary portion of a certain section formed at the outer side of the reaction portion is divided into three sections consisting of a front section, an intermediate section and a rear section in a lengthwise direction of the working electrode, wherein the front section, the intermediate section and the rear section are different in electrode width from one another, and wherein the front and rear sections including the boundary portion are relatively reduced in electrode width as compared to the intermediate section.

According to another aspect of the present invention, there is provided a structure of a working electrode of an electrochemical biosensor, the working electrode including a reaction portion of a certain section on which an analyte is fixed, wherein one end portion of the working electrode including the reaction portion and a boundary portion of a certain section formed at the outer side of the reaction portion is divided into two sections consisting of a front section and a rear section in a lengthwise direction of the working electrode, wherein the front section and the rear section are different in electrode width from each other, and wherein one section including the boundary portion of the front section and the rear section is relatively reduced in electrode width as compared to the other section.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a plan view illustrating an electrode structure of an electrochemical biosensor test strip according to one embodiment of the present invention;

FIG. 2 is a view illustrating the comparison between a conventional working electrode structure according to the prior art and a working electrode structure according to the present invention in terms of an area error generated according to a length error of a reaction portion of the working electrode;

FIGS. 3a and 3b are plan views illustrating an electrode structure of an electrochemical biosensor test strip according to another embodiment of the present invention; and

FIG. 4 is a plan view illustrating an electrode structure of a conventional electrochemical biosensor test strip according to the prior art.

### DETAILED DESCRIPTION OF THE PREFERRED EMBODIMENT

Reference will now be made in detail to the preferred embodiment of the present invention with reference to the attached drawings.

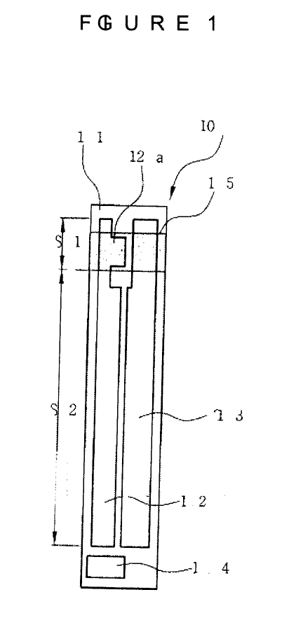

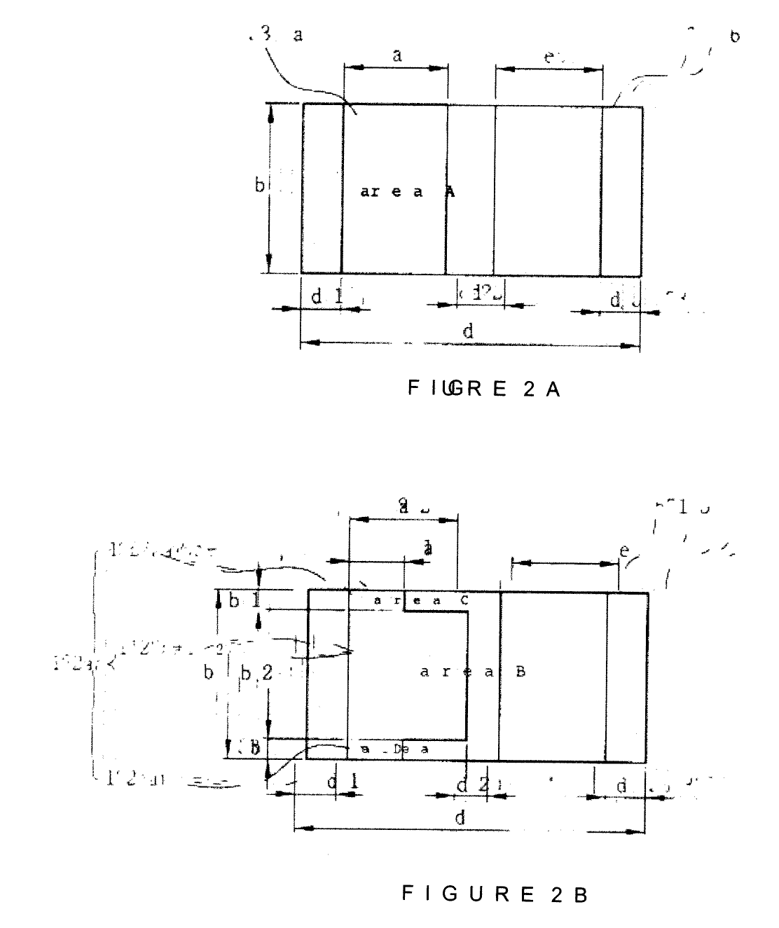

FIG. 1 is a plan view illustrating an electrode structure of an electrochemical biosensor test strip according to one embodiment of the present invention, and FIG. 2 is a view illustrating the comparison between a conventional working electrode structure according to the prior art and a working electrode structure according to the present invention in terms of an area error occurring according to a length error (lengthwise error of the electrode) of a reaction portion of the working electrode.

As shown in FIG. 1, the present invention is focused on modifying the structure of a working electrode 12 of an electrochemical biosensor so that although there is caused a length error in the reaction portion 12a of the working electrode 12 during the fabrication process of the test strip, an error for an area of the reaction portion can be reduced at the maximum.

As used herein, the term “a reaction portion 12a” of the working electrode 12 refers to a portion where there occurs a reaction between a sample and a reagent in the working electrode 12, i.e., a portion of the working electrode on which a reagent is fixed. This reaction portion 12a is a portion of the working electrode within the reagent portion 15 (a portion indicated by a shadow in FIG. 1). If the areas of the reaction portion 12a are identical to one another without any fine error for respective test strips 10, the same reaction occurs for the same sample, and hence the same current signal is output, so that a measurement error does not occur.

However, during the fabrication process of the test strip, if there occurs an error in the areas of the reaction portions 12a of the working electrodes 12 for respective test strips 10, despite the same sample there is a difference in a area reacting with the reagent. Thus, a measurement error occurs and reliability is degraded.

Accordingly, the present invention is characterized by the structure of the working electrode which can maximally restrict an area error of the reaction portion 12a although a length error occurs in the reaction portion 12a of the working electrode 12 after a reagent is fixed in the fabrication process of the test strip.

A reference numeral 15 in FIG. 1 denotes a reagent fixing portion where an analyte is fixed on the test strip 10. This reagent fixing portion 15 is defined by a rectangular area lengthily formed transversely over the working electrode 12 and the reference electrode 13.

In order to fix the reagent on the reagent fixing portion 15, after the remaining area of the electrodes except an exposed rectangular area corresponding to the reagent fixing portion 15 is insulated by using screen printing or film adhesion in a state where the electrodes 12 and 13 are formed by sputtering, the reagent is fixed on the exposed rectangular area.

In this case, since the reagent is fixed on the rectangular area lengthily formed transversely with respect to a longwise direction of the working electrode, an area error in the reaction portion 12a of the working electrode 12 occurs by a widthwise error (i.e., a vertical widthwise error in the drawing) of the reagent fixing portion 15 upon the fixing of the reagent.

Such a widthwise error of the reagent fixing portion 15 becomes a lengthwise error of the reaction portion 12a of the working electrode 12. The present invention is aimed at reducing the amount of errors occurring over the entire area of the reaction portion 12a although the same error occurs for this lengthwise error of the reaction portion 12a of the working electrode 12.

To achieve such an object of the present invention, the shape of the reaction portion 12a as a portion on which a reagent is fixed in the working electrode 12 and the shape of a boundary portion (a certain section formed over and below the reaction portion in the drawing) of a certain section positioned at the outer side of the reaction portion are improved as shown in FIG. 1.

That is, the working electrode 12 in the embodiment of the present invention is fabricated such that one end portion of the working electrode including the reaction portion and a boundary portion of a certain section formed at the outer side of the reaction portion is divided into various sections with respect to a lengthwise direction of the working electrode in such a fashion as to make the widths of the electrode different in the respective sections.

Referring to FIG. 1, in case where the entire lengthwise area of the working electrode 12 is divided into a portion S1 including the reaction portion 12a and a remaining portion S2, an intermediate section 12a-2 (see FIG. 2(b)) projecting laterally from the working electrode 12 within the reaction portion 12a in one end portion S1 is maintained in electrode width to be identical to the remaining portion S2, and the electrode width of the front and rear sections 12a-1 and 12a-3, i.e., the remaining sections in the reaction portion 12a except the intermediate section 12a-2 and the outer side boundary portion extending continuously from the front and rear sections 12a-1 and 12a-3 is reduced relatively as compared to the intermediate section 12a-2.

Referring to FIG. 2(b), when the reaction portion 12a of the working electrode 12 is divided into three sections consisting of a front section 12a-1, an intermediate section 12a-2 and a rear section 12a-3 in a lengthwise direction of the working electrode, the front section 12a-1, the intermediate section 12a-2 and the rear section 12a-3 are different in electrode width from one another. In this case, the front and rear sections 12a-1 and 12a-3 are relatively reduced in electrode width as compared to the intermediate section 12a-2.

Resultantly, in the structure of the working electrode 12, the shape of the reaction portion 12a has a “ [symbol] ” shape in the reagent fixing portion 15.

As such, in case where the front and rear sections 12a-1 and 12a-3, i.e., the remaining sections in the reaction portion 12a except the intermediate section 12a-2 in the reaction portion 12a in the working electrode 12 and the outer side boundary portion at the outer side of the reaction portion 12 extending continuously from the front and rear sections 12a-1 and 12a-3 are reduced in the electrode width relatively as compared to the intermediate section 12a-2, although a widthwise error (i.e., a vertical widthwise error in the drawing, i.e., a lengthwise error of the electrode of the reaction portion) of the reagent fixing portion 15 occurs upon the fixing of the reagent, such an error occurs at the boundary portion of the reagent fixing portion 15. Thus, a generation rate of an area error can be reduced as much as a reduced width of the front and rear sections 12a-1 and 12-3

In other words, although there occurs an error in the length of the reaction portion 12a of the working electrode 12 on which a reagent is fixed, the structure of the working electrode of the present invention causes a relatively small area error and can relatively reduce a change ratio of an area of the reaction portion of the working electrode upon the generation of the same process tolerance as compared to the structure of a conventional working electrode.

This working effect of the present invention will be described hereinafter in detail with reference to FIG. 2.

FIG. 2(a) illustrates a reagent fixing portion 6 of a reaction portion 3a of a conventional working electrode according to the prior art, FIG. 2(b) illustrates a reagent fixing portion 15 of a reaction portion 12a of a working electrode according to the present invention. The dimensions of the respective portions in FIGS. 2(a) and 2(b) are shown as one design example in table 1.

TABLE 1

| | Length (mm) |
|---|---|
| a | 1.524 |
| b | 2.50 |
| e | 1.576 |
| d1 | 0.60 |
| d2 | 0.70 |
| d3 | 0.60 |
| a1 | 0.808 |
| a2 | 1.75 |
| b1 | 0.30 |
| b2 | 1.90 |
| b3 | 0.30 |
| e | 1.576 |
| d1 | 0.60 |
| d2′ | 0.474 |
| d3′ | 0.60 |

In the conventional electrode structure and the inventive electrode structure, in order to make the entire area of the reagent fixing portions 6 and 15 identical to each other and make an area on which the reagent is fixed in the working electrode 12, i.e., the area of the reaction portions 3a and 12a identical to each other, the width a2 (equal to the width of the intermediate section in the reaction portion) of the working electrode of the present invention is 1.75 mm is set to be slightly larger than the width of the conventional working electrode which is 1.524 mm.

Further, in the conventional electrode structure and the inventive electrode structure, when the same lengthwise error occurs in the reaction portions 3a and 12a, an area error of the reaction portions 3a and 12a has been examined. The result of examination of the area error has been shown in the following tables 2 and 3.

TABLE 2

| b | Electrode area(mm²) | error |
|---|---|---|
| 2.4 | 3.658 | 4.0% |
| 2.5 | 3.810 | 0.0% |
| 2.6 | 3.962 | 4.0% |

TABLE 3

| b | Electrode area(mm²) | error |
|---|---|---|
| 2.4 | 3.729 | 2.1% |
| 2.5 | 3.810 | 0.0% |
| 2.6 | 3.891 | 2.1% |

The above Table 2 shows an area error generated according to a length error of a reaction portion of a conventional working electrode structure according to the prior art, and the above Table 3 shows an area error generated according to a length error of a reaction portion of a working electrode structure according to the present invention.

In FIG. 2, the entire area of the reaction portions 3a and 12a on which the reagent is fixed is indicated by the same area A in the conventional working electrode structure and the inventive working electrode structure according to the present invention. Particularly, when the areas of the front section 12a-1 and the rear section 12a-3 which are reduced in width in the electrode structure of the present invention are indicated by C and D, respectively, and the area of the intermediate section 12a-2 is indicated by B, the entire area A of the reaction portion 12a can be represented by B+C+D.

The entire area A of the reaction portion 3a in the conventional working electrode becomes a×b=1.576 mm×2.50 mm=3.810 mm.

In addition, the entire area A of the reaction portion 12a in the inventive working electrode can be calculated as follows:
area B=1.75 mm×1.90 mm=3.325 mm²
area C+D=0.808 mm×0.30 mm+0.808 mm×0.30 mm=0.485 mm
area A=B+C+D=3.325 mm²+0.485 mm²=3.810 mm²

As described above, when an error does not occur, the areas of the reaction portions 3a and 12a of the conventional and inventive electrode structures are 3.810 mm² which is identical to each other. In this case, when a vertical length b is changed by the process tolerance, an area change of the reaction portion of the working electrode is shown in Table 3.

Referring to Table 3, a length b is changed to 2.50±0.1 mm, i.e., 2.40 mm˜2.60 mm, there occurs an error of ±4% which is 3.658 mm²˜3.962 mm² in the conventional working electrode structure, and there occurs an error of ±2.1% which is 3.729 mm²˜3.891 mm² in the inventive working electrode structure.

As such, it can be seen that the same error occurs with respect to the length of the reaction portion of the working electrode, but an area error of the reaction portion is reduced by half approximately.

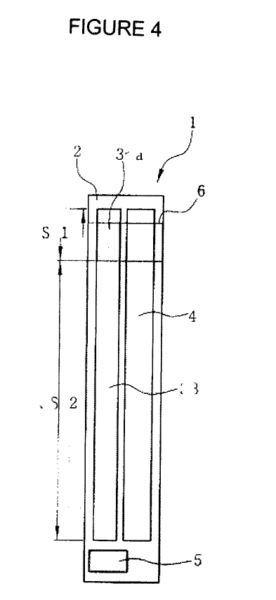

In the conventional working electrode structure and the inventive working electrode structure, since the reagent fixing portions 6 and 15 are lengthily formed transversely over the working electrodes 3 and 12, and the reference electrodes 4 and 13 (see FIGS. 1 and 4), a lengthwise (vertical direction on the drawing) error of the reaction portions 3a and 12a of the working electrodes 3 and 12 affects an area error of the reaction portion.

Particularly, since the lengthwise error of the reaction portions 3a and 12a occurs by lengthening or shortening of the upper and lower boundary portions of the reaction portion in the process of fixing the reagent by the insulating method after formation of the electrode, like the working electrode 12 of the present invention, in case where the front and rear sections 12a-1 and 12a-3 (upper and lower portions in the drawing) in the reaction portion 12a and the boundary portion at the outer side of the reaction portion 12a are relatively reduced in width, a change ratio of the area for the length error can be relatively reduced.

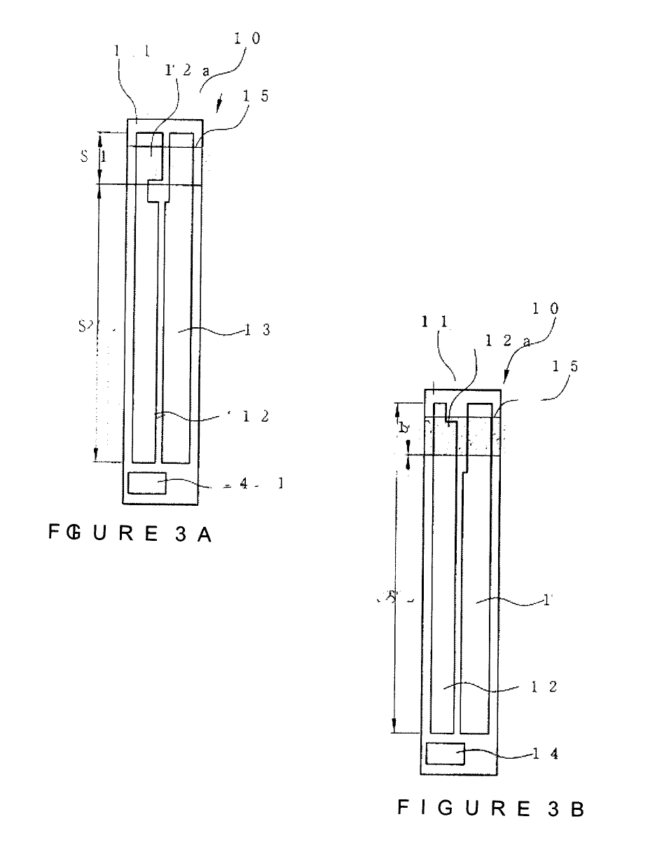

In the meantime, FIGS. 3a and 3b are plan views illustrating an electrode structure of an electrochemical biosensor test strip according to another embodiment of the present invention.

The electrode structure will be described hereinafter.

In the respective embodiments shown in FIGS. 3a and 3b, the reaction portion 12a and the outer side boundary portion (upper and lower boundary portions in the drawing) extending continuously from the reaction portion is modified in shape dissimilarly to the embodiment of FIG. 1.

That is, the embodiment of FIG. 1 shows an electrode structure in which the front and rear sections 12a-1 and 12a-3 in the reaction portion 12a is relatively reduced in electrode width as compared to the intermediate section 12a-2, but the embodiment of FIG. 3a shows an electrode structure in which one end portion of the working electrode including the reaction portion 12a of the working electrode 12 and a boundary portion of a certain section formed at the outer side of the reaction portion is divided into two sections consisting of a front section and a rear section in a lengthwise direction of the working electrode, in such a fashion that the front section and the rear section are different in electrode width from each other, and the front section (the lower portion in the drawing) including the boundary portion of the front section and the rear section is relatively reduced in electrode width as compared to the remaining rear section (the upper portion in the drawing).

On the contrary, the embodiment of FIG. 3b shows an electrode structure in which the rear section (the upper portion in the drawing) including the boundary portion of the front section and the rear section is relatively reduced in electrode width as compared to the remaining front section (the lower portion in the drawing).

As such, in case where the electrode structure of the present invention is configured such that any one of the front and rear sections in the working electrode is relatively reduced at a certain amount of electrode width as compared to the other section, when it is assumed that test strips having the same working electrode structure are produced repeatedly, an area change ratio of the reaction portion according to the length error of the reaction portion of the working electrode can be relatively reduced as compared to the case where the same electrode width is applied to the entire lengthwise sections of the working electrode.

As such, the working electrode structure of the biosensor according to the present invention has advantageous effects in that it is modified to the shape of “ [symbol] ” in which the front and rear sections in the reaction portion is relatively reduced in electrode width as compared to the intermediate section, or is modified to the shape of “ [symbol] ” or “ [symbol] ” in which any one of the front and rear sections in the working electrode is relatively reduced in electrode width as compared to the other section, by dividing the reaction portion into two sections of the front and rear sections in a lengthwise direction, so that in the process of fixing the reagent during the fabrication process of the test strip, although a lengthwise error occurs in the reaction portion of the working electrode, an error for the area of the reaction portion can be restricted at the maximum.

As apparent from the foregoing, according to the inventive working electrode structure of a biosensor, the shape of one end of the working electrode including a reaction portion is modified to have different electrode widths for each section along a lengthwise direction within the reaction portion, so that one end portion of the working electrode including a reaction portion is improved in shape, and thus although there is caused a length error in the reaction portion of the working electrode in the process of fixing a reagent during the fabrication of the electrode, an error for an area of the reaction portion can be restricted at the maximum, which results in a reduction in measurement error and an improvement in measurement reliability.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A structure of a working electrode of an electrochemical biosensor, the working electrode including a reaction portion of a certain section on which an analyte is fixed, wherein one end portion of the working electrode including the reaction portion and a boundary portion of a certain section formed at the outer side of the reaction portion is divided into three sections consisting of a front section, an intermediate section and a rear section in a lengthwise direction of the working electrode, wherein the front section, the intermediate section and the rear section are different in electrode width from one another, and wherein the front and rear sections including the boundary portion are relatively reduced in electrode width as compared to the intermediate section.

2. A structure of a working electrode of an electrochemical biosensor, the working electrode including a reaction portion of a certain section on which an analyte is fixed, wherein one end portion of the working electrode including the reaction portion and a boundary portion of a certain section formed at the outer side of the reaction portion is divided into two sections consisting of a front section and a rear section in a lengthwise direction of the working electrode, wherein the front section and the rear section are different in electrode width from each other, and wherein one section including the boundary portion of the front section and the rear section is relatively reduced in electrode width as compared to the other section.
